(19) United States
(12) Patent Application Publication
(10) Pub. No.: US 2011/0310260 A1
(43) Pub. Date: Dec. 22, 2011

(54) Augmented Reality

(75) Inventors: Janice Jordan, Fallbrook, CA (US); Dawn Elizabeth Lynch-Goodwin, Chalfont St. Giles (GB)

(73) Assignee: Minx, Inc., Fallbrook, CA (US)

(21) Appl. No.: 13/164,077

(22) Filed: Jun. 20, 2011

Related U.S. Application Data
(60) Provisional application No. 61/356,553, filed on Jun. 18, 2010.

(51) Int. Cl. G09G 5/00; H04N 5/225

(52) U.S. Cl. 348/207.1; 345/633; 348/E05.024

(57) ABSTRACT

Augmented reality may be provided. Providing augmented reality may comprise detecting an emblem located on an object. After the emblem is detected, an augmented reality object may be displayed on a display.

### BACKGROUND

The present application is related to U.S. Provisional Application Ser. No. 61/356,553 entitled “Augmented Reality Systems” filed on Jun. 18, 2010, which is hereby incorporated by reference in its entirety.

### BACKGROUND

Augmented reality (AR) is a term for a live direct or an indirect view of a physical, real-world environment whose elements are augmented by computer-generated sensory input, such as sound or graphics. One example of AR include first-person shooter video games that can simulate a player's viewpoint to give visual directions to a location, mark the direction distance of another person who is not in line of sight and give information about equipment such as remaining ammunition. Another example of AR is the yellow “first down line” seen on TVs while watching a professional or college football game.

### SUMMARY

Augmented reality may be provided. Providing augmented reality may comprise detecting an emblem located on an object. After the emblem is detected, an augmented reality object may be displayed on a display.

Both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment including an augmented reality processor;

FIG. 2 is a block diagram of the augmented reality processor;

FIG. 3 is a flow chart of a method for providing augmented reality;

FIG. 4 is a photograph of a display showing an emblem and an AR object; and

FIG. 5 is a photograph of a display showing an emblem with another AR object.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Augmented reality (AR) generally refers to a physical real-world environment with elements augmented by computer-generated imagery (e.g., virtual environment, such as 3D), enhancing and/or diminishing the perception of reality. The augmentation may be in real-time, and may include user interactivity with the assistance of technology such as computer vision, head-mounted display, virtual retinal display, object recognition, sensors, actuators, Artificial Intelligence (AI), etc. Further, the proportion of real to virtual may favor the real environment in some implementations, and the virtual in others.

Consistent with embodiments of the invention, an emblem may be affixed to a person's fingernail, toenail, or other body part. Consistent with embodiments of the invention, a plurality of emblems may be affixed to a plurality of fingernails, toenails, or body parts. In addition, a plurality of emblems may be affixed to a single fingernail, toenail, or body part. The emblems may be detected by an image capture device. Non-limiting examples of an image capture device include a webcam, digital camera, digital camcorder, phone built into a cell phone or other PDA type device.

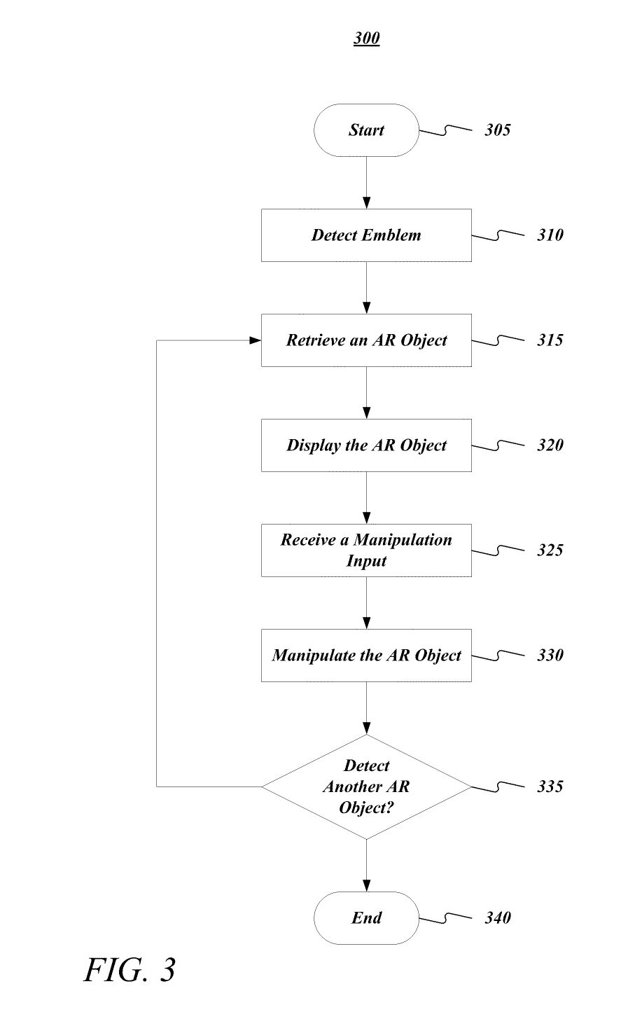

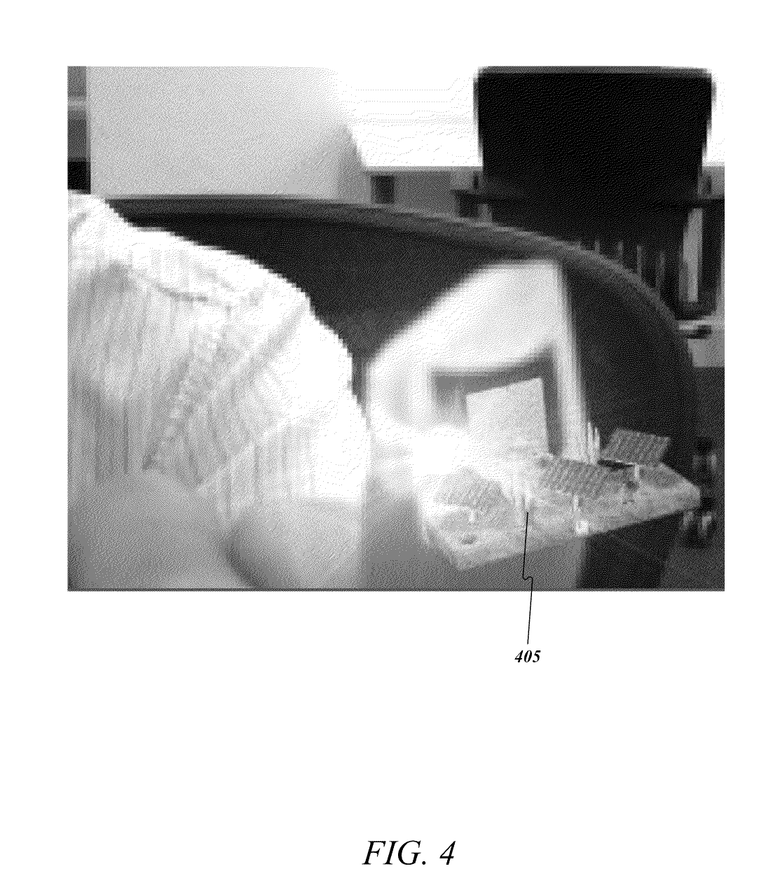

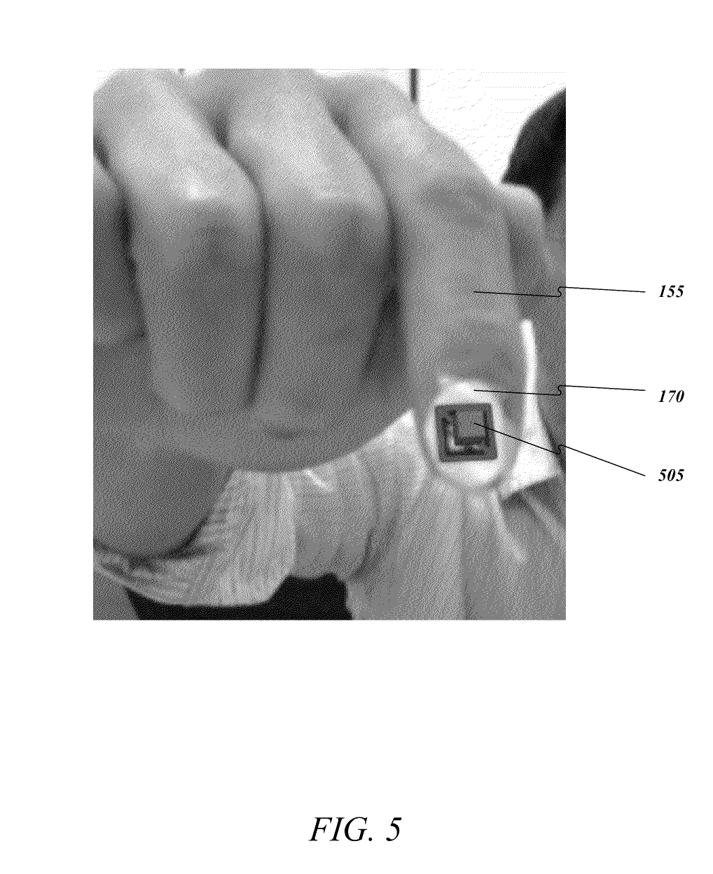

Upon detection, an AR toolkit may enable projection of 3D objects on top of the emblem (see 3D object 405 in FIG. 4 and 3D object 505 in FIG. 5). The AR toolkit may include software, hardware, or a combination of software. Consistent with embodiments of the invention, upon detection of multiple emblems, the AR toolkit may enable showing of different videos and objects per emblem. For example, upon detecting an emblem attached to each fingernail of a user's hand, a music video may be displayed on the user's middle finger, a 3D object (see floating cube in FIG. 5.) may be displayed on the user's index finger, a webpage may be displayed on the user's ring finger, and stock quotes or other data may be displayed on the user's pinky finger. The emblem may be any solid media applied to a mammalian nail.

Consistent with embodiments of the invention, AR systems may also include display and tracking devices as well as input devices to register the virtual information to the physical environment. Non-limiting examples of display, tracking devices, and input devices include computer vision, image recognition, video tracking, edge detection software and hardware.

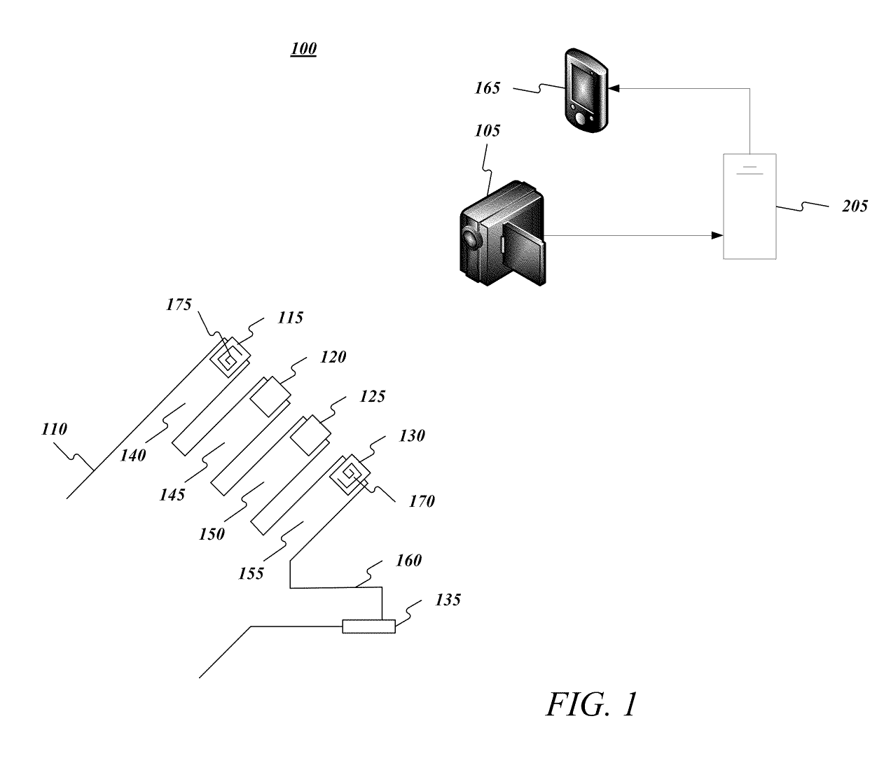

FIG. 1 is a block diagram of an operating environment 100 including an augmented reality (AR) processor 205. Embodiments of the invention may include AR processor 205 connected to a camera 105. Non-limiting examples of camera 105 include a webcam, a digital camera, a digital camcorder, and a camera equipped personal digital assistant (PDA) or cellphone.

During operation, various emblems, such as a first emblem 115, a second emblem 120, a third emblem 125, a fourth emblem 130, and a fifth emblem 135, may be attached to a person's hand 110. For instance, as show in FIG. 1, first emblem 115 may be attached to a pinky finger 140, second emblem 120 may be attached to a ring finger 145, third emblem 125 may be attached to a middle finger 150, fourth emblem 130 may be attached to an index finger 155, and firth emblem 135 may be attach to a thumb 160. While FIG. 1 shows emblems attached to fingers, embodiments of the invention may have the emblems attached to toenails and other body parts (e.g., hand 110, a foot, forehead, etc.). In addition, embodiments of the invention may have emblems attached to non-body parts. For instance, first emblem 115 may be attached to a notebook, a baseball cap, a belt, a belt buckle, a purse, a wallet, shoes, an automobile, a bicycle, etc.

During operation, a user may position fifth emblem 135 in proximity to camera 105. When fifth emblem 135 is within proximity to camera 105, camera 105 may detect fifth emblem 135 and active AR processor 205 to cause an AR object to appear on a display 165. For instance, once thumb 160 is moved into a field of view of camera 105, camera 105 may detect fifth emblem 135. Once camera 105 detects fifth emblem 135, AR processor 205 may cause a music video to appear on display 165 at the position where thumb 160 would normally appear. Embodiments of the invention may include, for example, the music video being superimposed on thumb 160's fingernail or the music video replacing the image of thumb 160's fingernail on display 165.

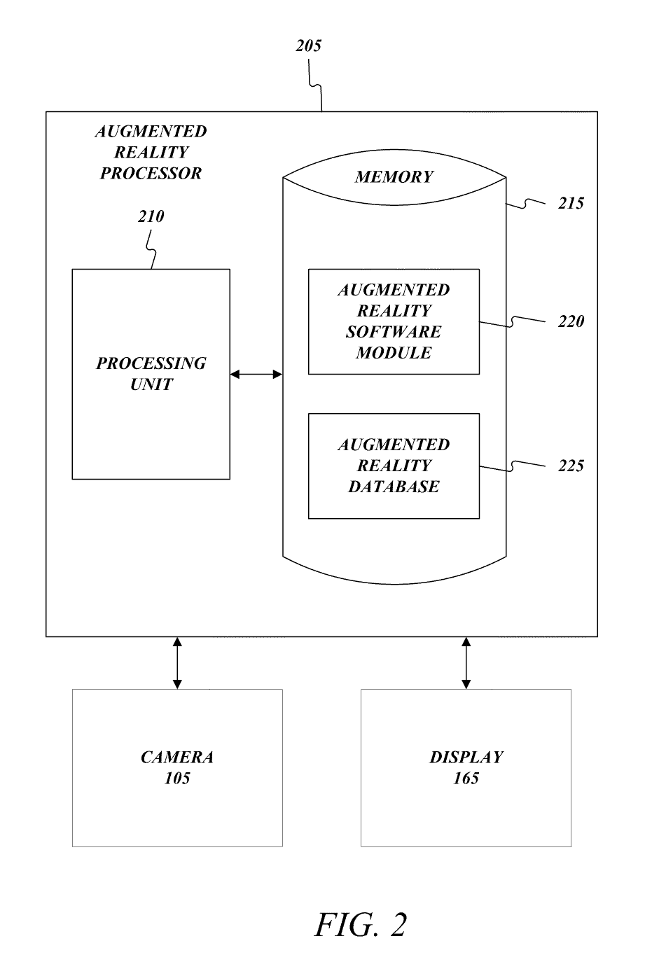

FIG. 2 shows AR processor 205 of FIG. 1 in more detail. As shown in FIG. 2, AR processor 205 may include a processing unit 210 and a memory unit 215. Memory unit 215 may include an AR software module 220 and an AR database 225. While executing on processing unit 210, AR software module 220 may perform processes for providing AR, in conjunction with, for example, one or more stages included in method 300 described below with respect to FIG. 3. Furthermore, AR software module 220 and AR database 225 may be executed on or reside in any element shown in FIG. 1. AR process 205 and display 165 may function together as one user device (e.g., a personal computer or a PDA).

AR processor 205 (“the processor”) may be implemented using a personal computer, a network computer, a mainframe, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

FIG. 3 is a flow chart setting forth the general stages involved in a method 300 consistent with an embodiment of the invention for providing augmented reality. Method 300 may be implemented using, for example, AR processor 205 as described in more detail above with respect to FIGS. 1 and 2. Ways to implement the stages of method 300 will be described in greater detail below.

Method 300 may begin at starting block 305 and proceed to stage 310 where AR processor 205 may detect an emblem. For example, second emblem 120 may be attached to ring finger 145 and when ring finger 145 and second emblem 120 are within a viewing area of camera 105, AR processor 205 may detect second emblem 120. For instance, second emblem 120 may have a particular visual pattern and AR processor 205 may utilize image recognition software to detect second emblem 120. For instance, first emblem 115 and fourth emblem 130 may contain unique designs 175 and 170, respectively and image recognition software may detect unique patterns associated with unique designs 175 and 170. Upon detecting the unique patterns, AR processor 205 may cause a music video to appear on first emblem 115 and a 3D object to appear on fourth emblem 130.

Embodiments of the invention may utilize other methods for detecting second emblem 120 such as radio frequency identification (RFID) technology and barcodes. In addition, second emblem 120 does not have to have a pattern that is visible to the human eye. For example, second emblem 120 may have an ultraviolent (UV) or infrared (IR) coating and camera 105 may be able to view object in the ultraviolent or infrared spectrums. Furthermore, camera 105 may be a high resolution camera and second emblem 120 may comprises a high resolution image. For instance, first emblem 115 may be provided to a user by a credit card company, bank, a credit union, or other financial institution and contain a unique high resolution image. Merchants or other service providers may have high resolution camera and specialized software that allow the user to pay for goods and services by presenting first emblem to a merchant's camera. In addition, concert promoters or bars/clubs, may provide patrons with an emblem containing concert or other admission information. Upon the patron arriving at the concert or bar/club, the patron may simple present his or her hand to security personnel having cameras. The emblem could then be read by the security personnel's camera to determine if the patron should be admitted or not.

From stage 310, where AR processor 205 detects second emblem 120, AR processor 205 may advance to stage 315 where AR processor 205 may retrieve an AR object from AR database 225. For example, at stage 315, upon detecting second emblem 120, AR processor 205 may retrieve a video from AR database 225. The AR object retrieved from AR database 225 may depend on the emblem detected. For instance, if AR processor 205 detects second emblem 120, a video may be retrieved from AR database 225. If AR processor 205 detects fifth emblem 135, a 3D image may be retrieved from AR database 225. The AR objects stored in AR database 225 may be a library of stock items such as images and 3D objects, etc. Embodiments of the invention also include AR database 225 being customable. For instance, a user may download videos such as music videos or movies and associate the download videos with various emblems. For example, the user may download a music video and may associate it with fifth emblem 135. When AR processor 205 detects fifth emblem 135, AR processor 205 may retrieve the music video from AR database 225

Once AR processor 205 retrieves the AR object from AR database 225 in stage 315, method 300 may continue to stage 320 where AR processor 205 may display the AR object on display 165. Embodiments of the invention may have AR processor 205 configured to superimpose the AR object on the emblem so that the emblem is not visible, but the AR object is. For example, in stage 320 AR processor 205 may display only an image and not fifth emblem 135. Embodiments of the invention may have AR processor 205 configured to display both the emblem and the AR object. For instance, in stage 320 AR processor 205 may display both fifth emblem 135 and the AR object (e.g., the music video).

After AR processor 205 displays the AR object in stage 320, method 300 may proceed to stage 325 where AR processor 205 may receive a manipulation input. Embodiments of the invention may comprise AR processor 205 being configured to detect movement of fifth emblem 135 (i.e., the manipulation input) and in response, AR processor 205 may cause the AR object to move. For example, the AR object may be a die and movement of fifth emblem 135 may be an input to “roll the die.” Embodiments of the invention may also comprise AR processor 205 configured to detect multiple emblems (e.g., fifth emblem 135 and fourth emblem 130). The manipulation input may be fourth emblem 130 and fifth emblem 135 being within a certain distance of each other.

After AR processor 205 receives the manipulation input in stage 325, method 300 may proceed to stage 330 where AR processor 205 may manipulate the AR object. For example, the AR object may be the die mentioned with respect to stage 325 and upon receiving the manipulation input (e.g., fifth emblem 135 moving), AR processor 205 may cause the image on display 165 to resemble a die rolling.

After AR processor 205 manipulates the AR object in stage 330, method 300 may proceed to decision block 335 where AR processor 205 may detect another emblem. If another emblem is not detected method 300 may then end at termination block 340. If another emblem is detected method 300 may proceed to stage 315 and another AR object may be retrieved from AR database 225. For example, at decision block 335 AR processor 205 may detect third emblem 125 and at stage 315 AR processor 205 may retrieve an image (e.g., a picture of a cat).

While FIG. 3 shows decision block 335 being implemented after stage 330, embodiments of the invention may comprise decision block 335, or any other stage of method 300, being executed before or after any other stage in method 300. For example, from starting block 305 AR processor 205 may detect fifth emblem 135 and proceed to stage 315 and retrieve the AR object (e.g., a die). After retrieving the AR object at stage 315, method 300 may proceed to decision block 335 and AR processor 205 may detect fourth emblem 130. After detecting fourth emblem 130 method 300 may proceed to stage 315 where another AR object may be retrieved (e.g. an image of a cat). After retrieving the AR object and the another AR object, method 300 may proceed to stage 320 where AR processor 205 may cause the AR object and the another AR object to be displayed on display 165.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing augmented reality, the method comprising:
detecting an emblem located on an object; and
displaying, in response to detecting the emblem, an augmented reality object on a display.

2. The method of claim 1, wherein detecting the emblem located on the object comprises detecting the emblem located on the object comprising a fingernail.

3. The method of claim 1, wherein the augmented reality object comprises a video and wherein displaying the augmented reality object on the display comprises displaying the video on the display.

4. The method of claim 1, further comprising:
receiving a manipulation input; and
manipulating the augmented reality object in response to the manipulation input.

5. The method of claim 1, wherein detecting the emblem comprises receiving an input from a camera when the emblem is within a viewing area of the camera.

6. The method of claim 1, further comprising retrieving, in response to detecting the emblem, the augmented reality object from a database.

7. The method of claim 6, wherein the emblem is a unique emblem and wherein retrieving the augmented reality object from the database comprises retrieving a unique augmented reality object corresponding to the unique emblem.

8. The method of claim 1 further comprising:
detecting a second emblem located on a second object; and
displaying, in response to detecting the second emblem, a second augmented reality object on the display.

9. The method of claim 8, wherein the augmented reality object and the second augmented reality object are different.

10. The method of claim 8, wherein the augmented reality object comprises a video and the second augmented reality object comprises a 3D object.

11. The method of claim 8, further comprising manipulating the augmented reality object, wherein manipulating the augmented reality object comprises manipulating the augmented reality object in response to displaying the second augmented reality object.

12. A system for providing augmented reality, the system comprising:
a memory storage; and
a processing unit coupled to the memory storage, wherein the processing unit is operative to:
detect an emblem located on an object; and
send an augmented reality object to a display.

13. The system of claim 12, wherein the object is a fingernail.

14. The system of claim 12, wherein the augmented reality object comprises at least one of the following: a video, a 3D object, and a picture.

15. The system of claim 12, wherein the processor is further configured to:
receive a manipulation input; and
manipulate the augmented reality object in response to the manipulation input.

16. The system of claim 12, wherein the processor configured to detect the emblem comprises the processor configured to receive and input from a camera when the emblem is within a viewing area of the camera.

17. The system of claim 12, further comprising the processor being configured to retrieve, in response to detecting the emblem, the augmented reality object from a database.

18. The system of claim 12, wherein the emblem is a unique emblem and wherein retrieving the augmented reality object from the database comprises the processor being configured to retrieve a unique augmented reality object corresponding to the unique emblem.

19. An augmented reality system comprising:
an emblem;
a camera; and
a computer connected to the camera and having a processor, a memory, and a display, the computer connected to the camera and having logic stored in the memory, the logic configured to cause the processor to:
detect when the emblem is within a viewing area of the camera,
retrieve an augmented reality object, in response to detecting when the emblem is within the viewing area of the camera, from the memory,
display an augmented reality object on the display,
receive a manipulation input, and
manipulate the augmented reality object in response to receiving the manipulation input.

20. The augmented reality system of claim 19,
wherein the emblem is attached to at least one of the following: a finger nail, a toenail, and an article of clothing; and
wherein the computer and the camera are elements of a smartphone.
